(19) United States
(12) Patent Application Publication
(10) Pub. No.: US 2019/0081706 A1
(43) Pub. Date: Mar. 14, 2019

(54) COMMUNICATION THROUGH WINDOW USING FREE-SPACE OPTICAL DATA COMMUNICATION

(71) Applicant: Alcatel-Lucent USA Inc., Murray Hill, NJ (US)

(72) Inventors: David Neilson, Murray Hill, NJ (US); Michael Zierdt, Murray Hill, NJ (US); Yee Leng Low, Murray Hill, NJ (US); Nagesh Basavanhally, Murray Hill, NJ (US)

(21) Appl. No.: 15/873,151

(22) Filed: Jan. 17, 2018

Related U.S. Application Data
(60) Provisional application No. 62/557,046, filed on Sep. 11, 2017.

(51) Int. Cl. H04B 10/29; H04B 10/114; H04B 10/40; H04B 10/80

(52) U.S. Cl. CPC H04B 10/29; H04B 10/808; H04B 10/40; H04B 10/1143

(57) ABSTRACT

The present disclosure is directed to an apparatus comprising two components mounted on opposite sides of a window but proximate to each other where the two components are communicatively coupled through an optical link and where each component can be communicatively coupled with a wireless data source. In another embodiment, the components can include one or more of light indicators, audio indicators, and magnetic assistance to guide an optical alignment between the two components. In another embodiment, the components can include one or more of an array of lasers, larger photo diodes, adjustable lenses, and can utilize gain parameters to increase the tolerance level for a misaligned optical link. In another embodiment, methods are disclosed to perform communication coupling via an optical transmission link. In another embodiment, methods are disclosed to assist a user in optically aligning the two components.

### CROSS-REFERENCE TO RELATED APPLICATION

This application claims the benefit of U.S. Provisional Application Ser. No. 62/557,046, filed on Sep. 11, 2017, entitled “COMMUNICATION THROUGH WINDOW USING FREE-SPACE OPTICAL DATA COMMUNICATION,” commonly assigned with this application and incorporated herein by reference in its entirety.

### TECHNICAL FIELD

This application is directed to apparatus, systems, and methods that can form or use a free-space optical communication link through a window.

### BACKGROUND

This section introduces aspects that may help facilitate a better understanding of the inventions. Accordingly, the statements of this section are to be read in this light and are not to be understood as admissions about what is prior art or what is not prior art.

Traditionally, to provide data services to a home or business requires that a physical line be deployed between the home or business and a designated junction point outside of the home or business. For example, a cable line, a fiber optic line, a phone line, and other physical connection types all have been used. The installation and maintenance of a physical connection can be expensive and time consuming. In addition, such physical connections can be easily disrupted through other related or non-related events near the physical connection, for example, activity at a construction site or the downing of a utility pole. The communication industry has considered wireless access technologies so that a physical line is no longer needed. Communications can be established with a wireless data access point, i.e. a base station, a communication junction equipment, and a remote device.

### SUMMARY

A wireless access connection may be difficult to form between an access node inside a home or business and a wireless transceiver outside the home or business due to construction materials, e.g., concrete structures, window materials, and metal structures. Such construction materials may too strongly attenuate wireless transmissions between the inside and outside of the home or business.

Various embodiments of apparatus and methods, which are described herein, may be beneficial to providing a wireless network connectivity into a structure, e.g. having radio frequency (RF) attenuating windows. While such embodiments may provide improvements in performance and/or reduction of cost relative to conventional approaches, no particular result is a requirement of the present disclosure unless explicitly recited in a particular claim. Various embodiments are able to form an access connection by forming a free-space optical data link through a window of a building.

One embodiment provides an apparatus comprising two components mounted on opposite sides of a window but proximate to each other. The two components are coupled via an optical transmission link through the window. Each of the two components is communicatively coupled to a separate wireless data access point located on the same respective side as the component to which it is coupled.

Other embodiments provide for methods of maintaining a communications link and for methods of aligning the two components to achieve a satisfactory optical transmission throughput.

### BRIEF DESCRIPTION

The embodiments of the disclosure are best understood from the following detailed description, when read with the accompanying Figures. Reference is now made to the following descriptions taken in conjunction with the accompanying drawing, in which:

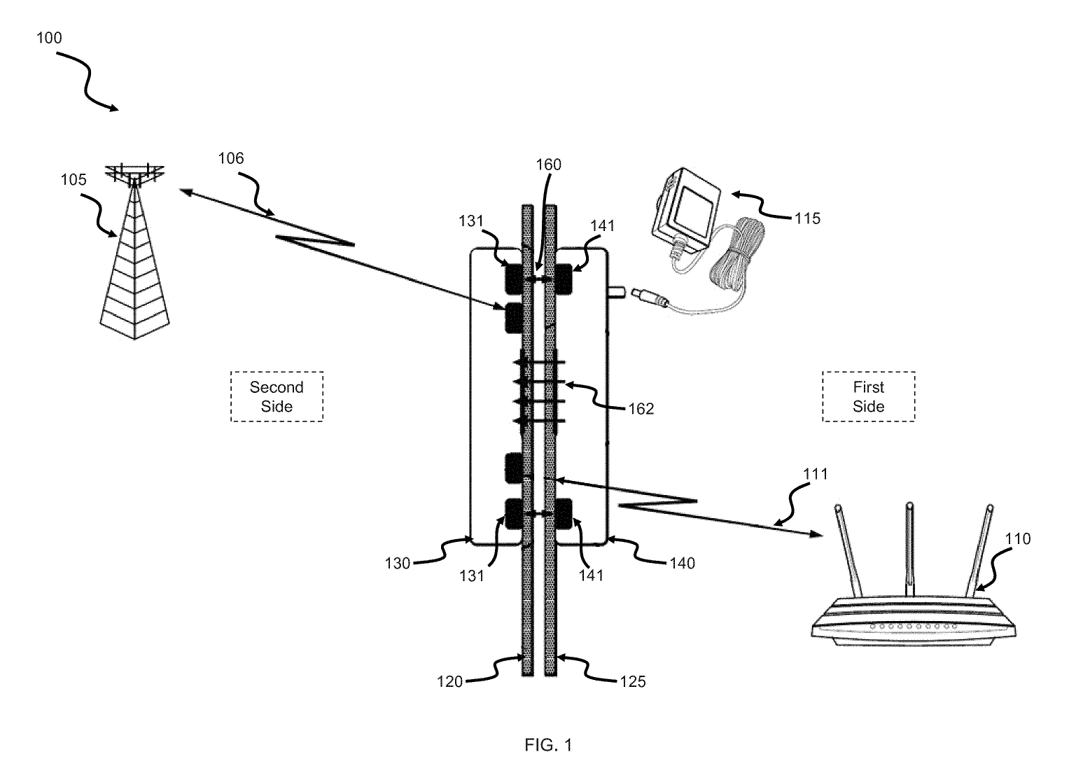

FIG. 1 illustrates a diagram demonstrating an example communication system passing through a window;

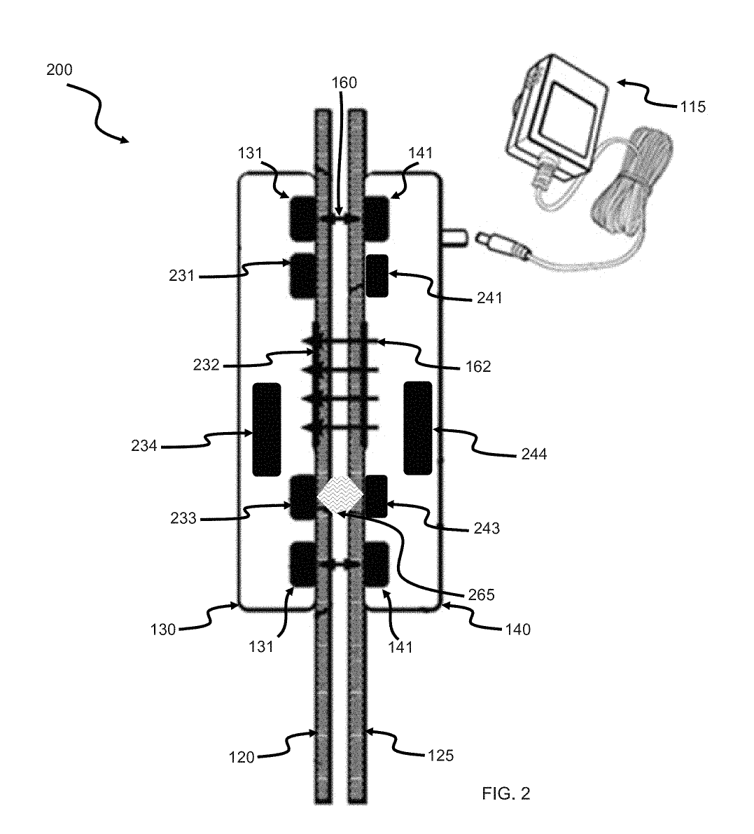

FIG. 2 illustrates a diagram of an example apparatus capable of communicating optically through a window;

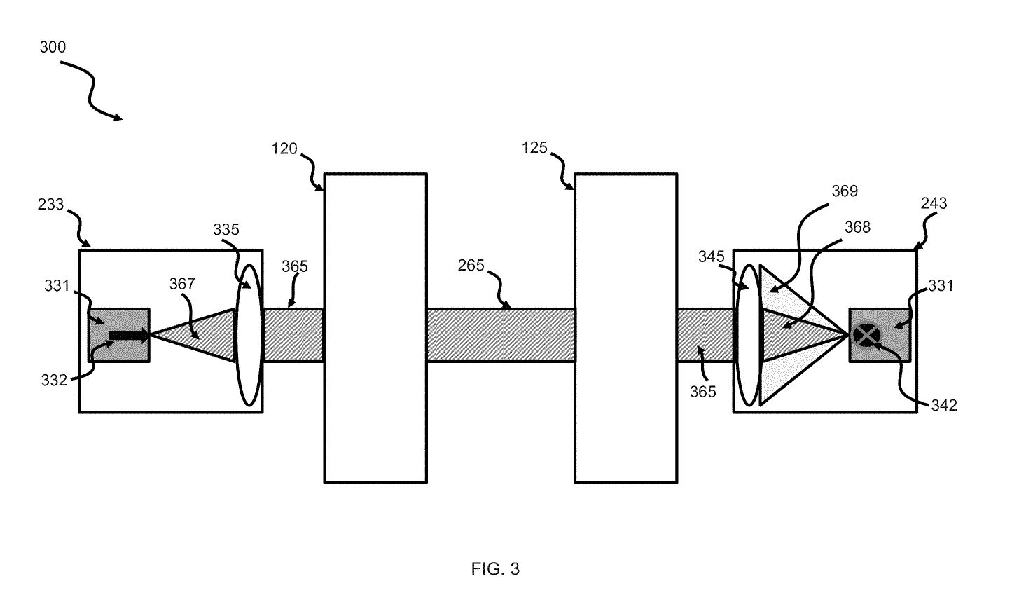

FIG. 3 illustrates a block diagram demonstrating an example optical alignment method;

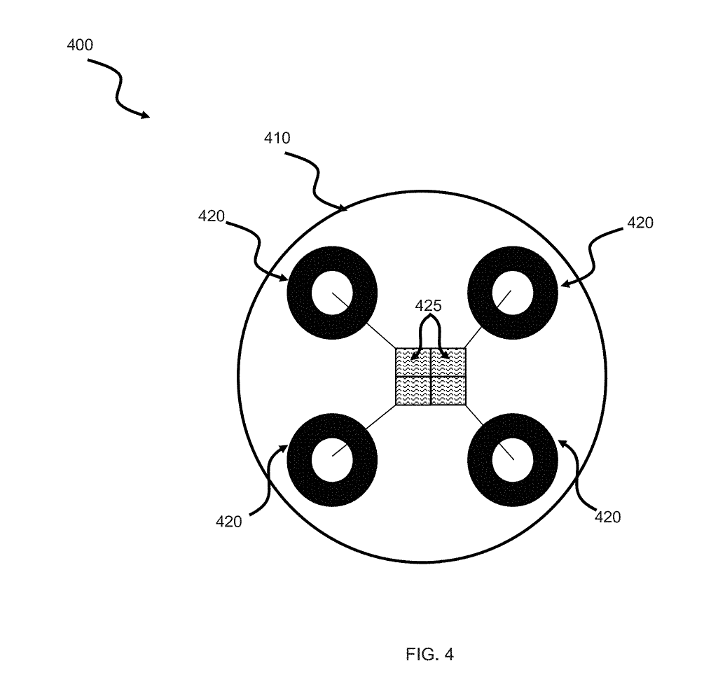

FIG. 4 illustrates a diagram of an example multiple laser array;

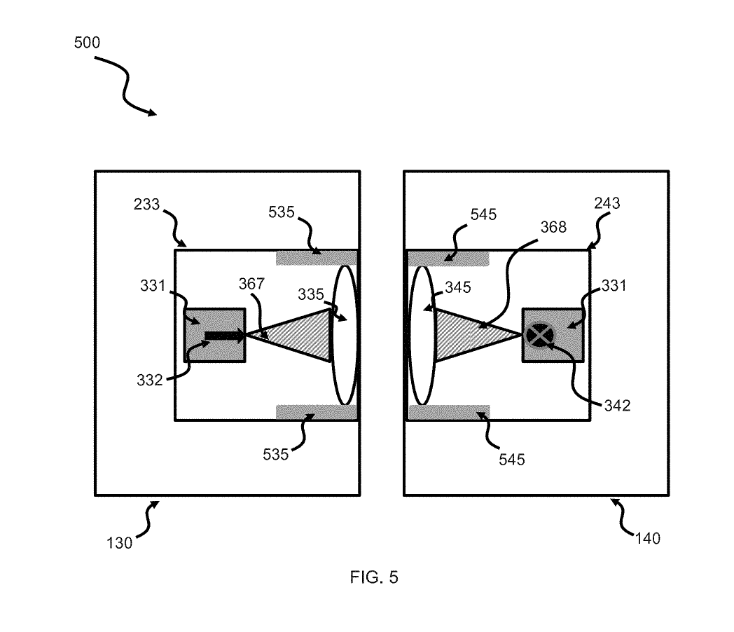

FIG. 5 illustrates a block diagram of an example alignment system using magnets;

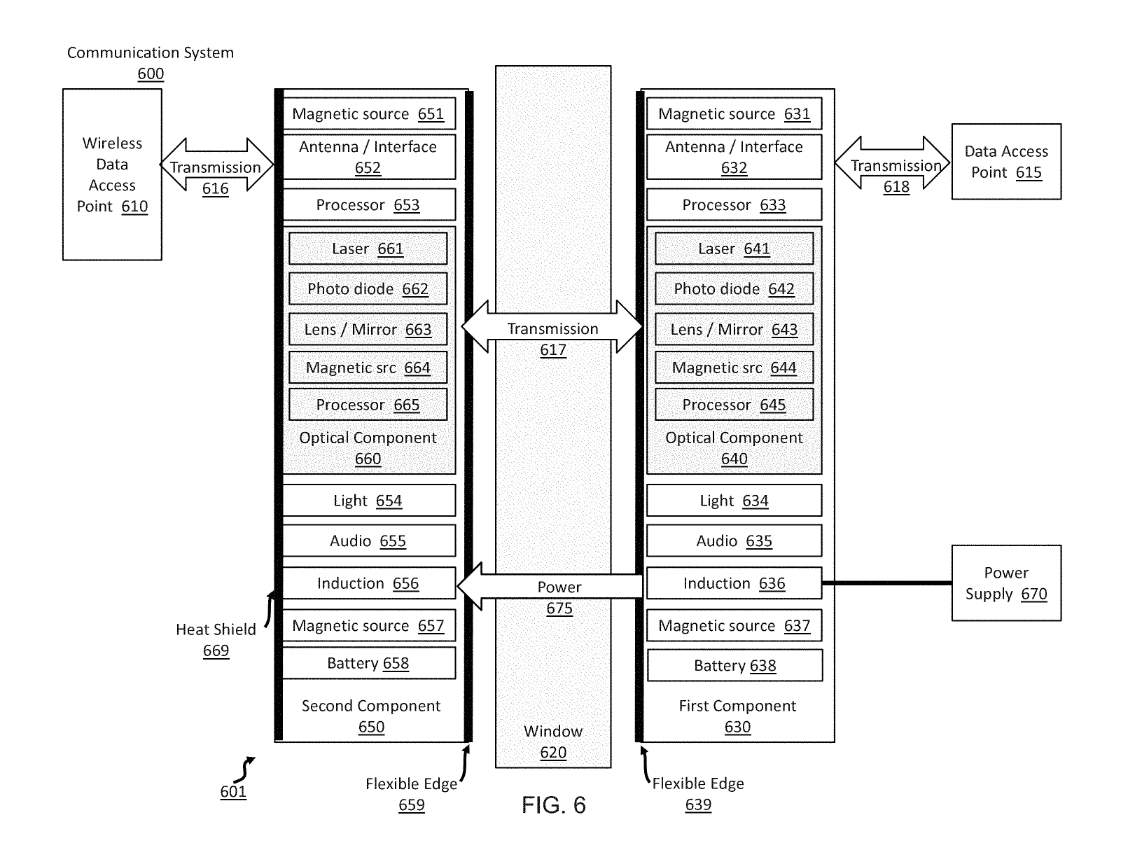

FIG. 6 illustrates a block diagram of an example communication system;

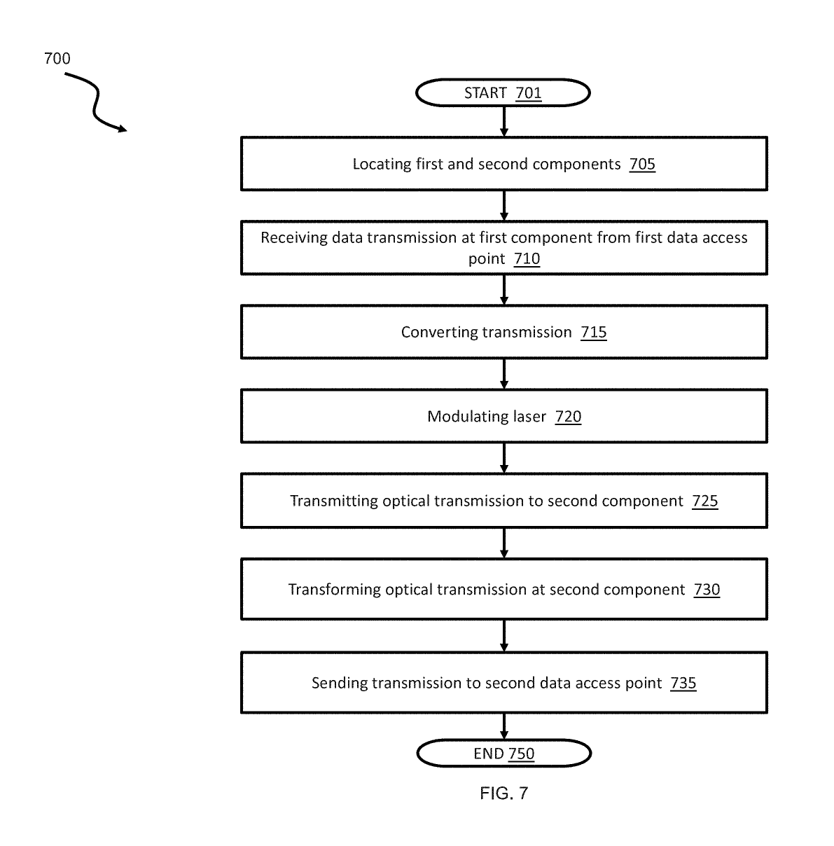

FIG. 7 illustrates a flow diagram of an example method for communicating data between an inside data access point and an outside wireless data access point; and

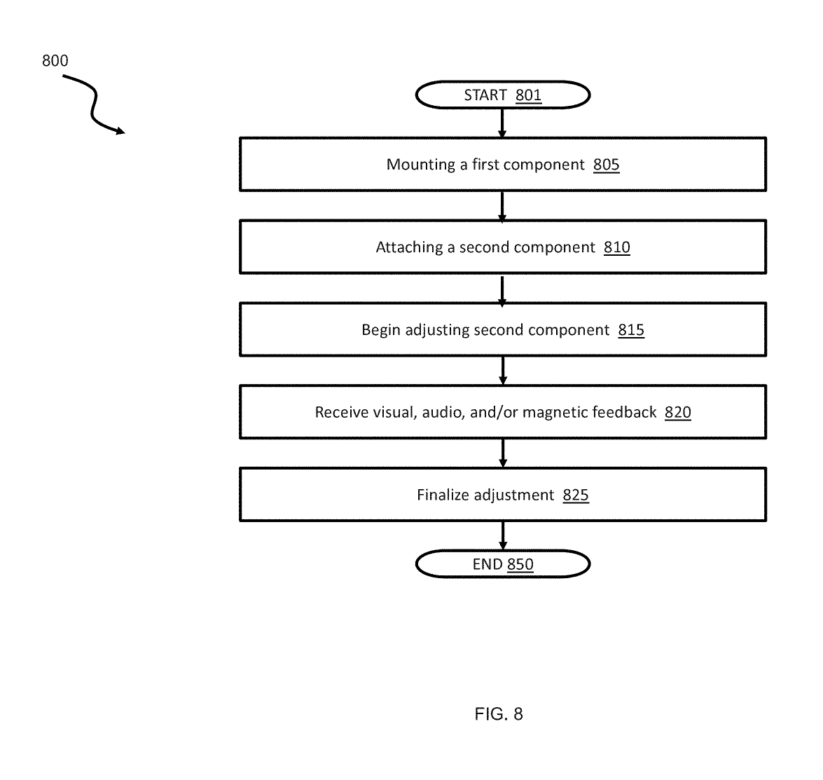

FIG. 8 illustrates a flow diagram of an example method for optically aligning an inside component and an outside component.

Herein, various embodiments are described more fully by the Figures and the Detailed Description. Nevertheless, the inventions may be embodied in various forms and are not limited to the embodiments described in the Figures and Detailed Description.

### DETAILED DESCRIPTION

The description and drawings merely illustrate the principles of the disclosure. It will thus be appreciated that those skilled in the art will be able to devise various arrangements that, although not explicitly described or shown herein, embody the principles of the disclosure and are included within its scope. Furthermore, all examples recited herein are principally intended expressly to be for pedagogical purposes to aid the reader in understanding the principles of the disclosure and concepts contributed by the inventor(s) to furthering the art, and are to be construed as being without limitation to such specifically recited examples and conditions. Moreover, all statements herein reciting principles, aspects, and embodiments of the disclosure, as well as specific examples thereof, are intended to encompass equivalents thereof. Additionally, the term, “or,” as used herein, refers to a non-exclusive or, unless otherwise indicated. Also, the various embodiments described herein are not necessarily mutually exclusive, as some embodiments can be combined with one or more other embodiments to form new embodiments.

In establishing a wireless communication path between a wireless data access point, i.e. a base station, a junction equipment, a short range transceiver, or other equipment designed to handle communications from many devices, the wireless path, i.e. the path through which the radio frequency (RF) signals travel, is ideally free from strong attenuation. However, the wireless path can be blocked or can cause strong attenuation of wireless signals. For example, if a device is located inside a building and a wireless data access point is located a distance away from the building, the wireless signal often needs to pass through a wall, window, or other construction material to communicate with a transceiver inside the building. As the signal passes through the material, the signal is typically subjected to attenuation. The attenuation may necessitate communication at a lower data speed and/or a lower quality, or may produce a lower reliability communication link.

Even when a direct line of sight is established, there is often signal attenuation from intervening material of the building. For example, a glass window may appear to be transparent to visible light, but the glass can be coated by various materials that can strongly attenuate a RF wireless signal. Glass window technology has undergone an energy saving evolution over the past several decades, e.g., from single panes to ultralow-emission windows. While the earliest energy saving windows were constructed as a sandwich of clear glass panes using the vacuum-flask principle, some modern low-emission windows include panes with coatings of metal and/or metal oxides. These coatings can cause strong attenuation for RF wireless communications. For example, window glass coatings can reduce a transmission of wireless signals in the frequency range anywhere between 10.0 mega-Hertz (MHz) and 100.0 giga-Hertz (GHz), depending on the type of coatings used. The resulting attenuation and disruption of the RF signals can make it difficult to provide high speed data access across such coated windows using, for example, a 3G, 4G, or 5G standard communication network.

Windows can also vary as to material. For example, a window can be manufactured from a polycarbonate or other material while maintaining the window's transparency for visible light. But, non-glass materials, similar to the glass coatings described above, can cause strong attenuation of an RF signal when the signal passes through such a material.

For this disclosure, a window is a section of a wall of a building that allows at least some visible light to pass through. A window may or may not be fully transparent to visible light. For example, translucent windows of buildings are also considered windows for this disclosure. For example, without limitation, the term window includes a traditional building single pane window, a building double pane and low-e glass window, a plate glass window typically found in commercial buildings, and a full floor to ceiling wall made of glass or a specialized material where at least some visible light is able to pass through. Herein, the term window also includes a conventional window having a coating on one or more surfaces thereof provided that the window has some transparency to visible light.

Various embodiments relate to an apparatus and methods whereby a first portion of the apparatus is capable of forming a short, free-space, optical, data-communication link with a facing second portion of the apparatus located on the other side of a window. In some embodiments, the apparatus further may provide a free-space, optical communication link segment between a node inside a building with the window and a wireless data access point or other junction equipment outside of the building. In some embodiments, the same short free-space, optical communication link can be utilized by the components of the apparatus to exchange information, instructions, or other data necessary to maintain appropriate operation of the apparatus.

For example, lasers can be incorporated into the apparatus to provide for the optical transmission. The lasers can operate, e.g., in the 0.3 to 0.8 micron wavelength band as those are the typical wavelengths, i.e. visible light and near infrared light, which typically passes through coatings on a window of a building. The lasers can be of various types, such as a vertical cavity surface emitting laser (VCSEL).

With such an apparatus in place, a device may be able to attain a pre-designated level of bi-directional communication throughput regardless of the coating(s) applied to a window, or the material used in the manufacture of the window, when the window is in the communication transmission path. The thickness of the window, i.e. all panes plus one or more intervening space, can result in each component of the apparatus to be separated by a thickness amount. As this thickness increases, the free-space, optical communication signal through the window can be degraded, but the overall communication signal throughput can still be higher than for conventional communication apparatus.

The apparatus includes two components: a first component mounted to a first side of a window and a second component mounted to a second side of the window to face the first component. The components can be mounted using an available method, such as by adhesive, tape, magnets, clips, brackets, and other attachment mechanisms. The attachment mechanisms may be electrically conductive, electrically non-conductive, optically conductive, or optically non-conductive as needed for the specific implementation. In addition, one or more of the components can include a heat shield material, for example, to maintain an appropriate operating temperature regardless of the amount of sunshine striking the component.

This disclosure also relates to methods to align the apparatus' two components on both sides of the window. A misalignment of the components can decrease the signal throughput, i.e. can require a drop in data speed, a drop in quality of data transmitted, and a drop in communication reliability. In addition, defects in the window may result in one pane being angled differently than another pane, for example, in a double pane window. This can also cause a misalignment of the apparatus components. For example, a typical double pane window can include two 6.0 millimeter (mm) panes of glass separated by a space of about 12.0 mm. Affecting the angle of each pane of glass can be bowing of the panes, space wedges, and a variation in the thickness of the glass across the pane. These variations can typically add up to +/−0.3 degrees of angle. Non typical windows or windows manufactured from other materials can cause a larger variation of angle between the two facing components of the apparatus.

For the short free-space optical link, the components can be constructed to compensate for an acceptance diameter error, i.e. the (x,y) positioning error on a pane of the window of one component relative to the other component, and the acceptance angle error, i.e. the angular error from parallel optimal optical transmission and reception directions for the two facing components of the apparatus. Making either the acceptance diameter or the acceptance angle more tolerant for misalignment typically results in the other factor less tolerant to misalignment. For example, if a detector diameter is 0.2 mm and the detector numerical aperture (NA) is 0.5 then the apparatus can accommodate a +/−1.0 degree of acceptance angle error with a +/−3.0 mm acceptance diameter error. By adjusting the detector size and NA, varying combinations of acceptance angles and acceptance diameters can be determined. The chart below demonstrates sample options that can be employed using larger and smaller tolerance values, but the options available are not limited to what is listed below:

| | Acceptance angle | Acceptance |
|---|---|---|
| Option | tolerance | diameter tolerance |
| 1 | +/−1.0 degree | +/−3.0 mm |
| 2 | +/−0.5 degrees | +/−6.0 mm |
| 3 | +/−2.0 degrees | +/−1.5 mm |

The alignment methods disclosed can provide feedback to a user installing the apparatus so that a satisfactory relative positioning of each component of the apparatus can be achieved within the tolerance values selected.

In some embodiments, the component housing can be designed to allow and aid in the alignment process, for example, the optical and lens components can have a leveling mechanism, and a flexible material can be included around the edge of the housing that is facing the window to allow for some angle adjustment. This can increase the tolerance angle, for example, if the inside of the window pane(s) is not angled to be parallel the outside of the window pane(s) at an apparatus mounting location.

One method of overcoming a relative misalignment of apparatus' components can be to increase the optical communication beam width using a lens system, a mirror system, or a set of lenses and mirrors. After the optical transmission is received by the other component, a similar set of lens(es) and/or mirror(s), e.g., can be used to reduce the optical beam width to its original diameter for further processing. In addition, a magnet or system of magnets can be included to provide an alignment of the lens. The magnet or system of magnets can be constructed to automatically align the lens or mirror system of the two facing components into a better alignment position. The magnet or system of magnets can be, for example, include a permanent magnet, an electromagnet, or a solenoid, and may include ferromagnetic materials, or a magnet or system of magnets on the facing of the other component of the apparatus.

Another method of overcoming a relative misalignment of apparatus' components is to include an array of one or more alignment lasers in one or both components. When the two components are properly relatively positioned, each laser of one of the components would be aligned with a corresponding edge of a photo diode detector in the facing of the other component. Should a misalignment of components occur, the array of lasers increase the opportunity for at least one of the lasers to be properly aligned on the corresponding photo diode detector. For example, such an alignment array using VCSELs can increase the acceptance diameter tolerance from 3.0 mm to 6.0 mm while maintaining the same acceptance angle tolerance.

Another method of overcoming a relative misalignment of apparatus' components can use photo diodes that have a larger detector area. For example, an avalanche photo diode (APD) can be used with a detector greater than 200.0 micrometers (um). Larger APD can be utilized and the resultant roll off of signal response, due to relative misalignment of the facing components of the apparatus, can be compensated through gain.

The laser module or another type of optical beam collimator can be configured to form a collimated light beam where the light beam has a diameter of at least 2.0 to 10.0 times larger than the diameter of an output aperture of the optical transceiver. In addition, an optical intensity detector, such as the APD described above, can have a diameter that is 2.0 to 10.0 times smaller than the diameter of the light beam.

For example, using a 500.0 um diameter APD, a 2.0 GHz signal can be reduced by about 5.0 decibels (dB). However, the APD has a gain parameter of about 20 dB, therefore, the gain can compensate for the additional signal loss. As a result, in this example, a +/−3.0 mm per 1.0 degree of acceptance diameter tolerance may be increased to +/−6.0 mm per 1.0 degree. Utilizing even larger detectors can reduce the effective sensitivity so a balance is needed between the size of the detector and the available gain to compensate for the signal loss due to relative misalignment.

For aiding a user in relatively aligning the two components of the apparatus, the components can have light indicator(s), for example, light emitting diode(s) (LEDs) and/or audible indicator(s). Various combinations of indicators can be used to guide the alignment process to achieve at least a satisfactory optical signal transmission throughput. In addition, a magnet or magnets can be included to provide aid to a user in relatively aligning the two components. A set of magnets can be arranged to guide the components to at least a satisfactory alignment state. These magnets can be permanent magnets, electromagnets, or solenoids.

Combining the disclosures, after the apparatus is installed and aligned, an example optical data communication system can comprise a device that sends a data transmission, for example, through Wi-Fi or other RF transmissions, to a first component of a cross-window, optical communication, apparatus on the device's side of a window. This first component of the cross-window, optical communication, apparatus remodulates the received data stream of the WIFI or RF transmission onto an optical carrier. For example, a component of the cross-window, optical communication apparatus, receiving a transmission from an outside/distant wireless data access point, may remodulate, onto an optical carrier, the data stream of a received wireless signal from 28.0 GHz to 2.0 GHz frequency range, and a component of the cross-window, optical communication apparatus, receiving a transmission from a proximate/near wireless data access point, may remodulate, onto an optical carrier, a received wireless signal from 5.0 GHz to 2.0 GHz frequency range. Other carrier frequency remappings are possible depending on the equipment and standards being used at the time of signal transmission.

The component can send the signal through the window, while increasing the optical communication beam's width. The second component of the cross-window, optical communication apparatus, located on the opposite side of the window, can receive the data-modulated optical beam and reduce the width of the optical beam, e.g., to approximately its original width. The second component may modulate the received data stream onto an appropriate wireless carrier, for example in the 2.0 GHz to 5.0 GHz or in the 28.0 GHz frequency range, so that the data signal can be transmitted to a wireless data access point or junction equipment.

In various embodiments, the apparatus also supports cross-window, free-space, optical data communication in the reverse direction and/or in both directions.

Turning now to the figures, FIG. 1 illustrates a data communication system 100 with an example of a free-space optical data communication link across a window of a building. The system 100 includes a distant wireless data access point 105 and an outside component 130 of a cross-window, free-space optical communication, apparatus, wherein both elements are on an outside of a building, i.e., labeled as second side of the window of the building. The system 100 also includes an inside component 140 of the cross-window, optical communication apparatus, a power supply 115 connected to the component 140, and a proximate data access point 110, wherein said elements are located inside of the building, i.e., labeled as first side of the window of the building. Between the components 130 and 140 is a single or double pane window, e.g., including an outside pane 120 and an inside pane 125. In other implementations, the window may have various quantities of panes, such as a one, two, three, four, or more pane window. In these aspects, outside pane 120 is the pane proximate to the outside of the building, i.e. outermost pane with respect to the building, and inside pane 125 is the pane proximate to the inside of the building, i.e. innermost pane with respect to the building.

The system 100 is a communication link between a first side as inside a building and second side as outside a building. The first and second sides, however, can both be inside or outside a building. For example, a glass wall inside of a large building may divide the first side and second side where neither side is a location outside of the building.

The component 130 can be mounted to the window 120 by various means, for example, by an adhesive, clips, brackets, magnets, or other means. The component 140 can be similarly mounted to window 125. The component 130 and component 140 typically need to be approximately relatively aligned so that an adequate optical communication throughput can be achieved there between. Such mounting and alignment can be aided, e.g., by magnets 131 and 141 which can hold the respective components facing, under magnetic force 160, against the window panes 120 and 125 and can guide the relative placement and alignment of the components 130 and 140. When adequately aligned, the component 140 can provide, in some embodiments, power 162 to the component 130, via a wireless power source, for example, induction coils (not shown).

Wireless data access point 105 can be of various types of data access points, such as, a wireless base station, or wireless junction equipment. Wireless data access point 105 can be a node of a provider of network service, such as an internet service provider (ISP), and may often be capable of providing access service to multiple subscribers to the network service, e.g., to multiple buildings or across multiple windows in one building. The wireless data access point 105 often may provide connectivity by a suitable communication protocol standard. Without implied limitation, the wireless data access point 105 may support TDMA (time-division multiple access), CDMA (code-division multiple access), FDMA (frequency-division multiple access), IEEE 802.16 (sometimes referred to as WiMAX), ITU 4G, LTE, and/or the 5G standard.

Wireless data access point 105 may have a bi-directional communication link 106 with the outside component 130. The outside component 130, after receiving signal 106, can remodulate the data stream of the signal 106 onto an optical carrier to be optically transmitted across the window to the inside component 140. The inside component 140 can remodulate the data stream of the received optical signal appropriately, e.g., for transmission as a transmission signal 111 to data access point 110. The data access point 110 can be communicatively coupled with the inside component 140 by a wired or wireless communication method. In alternative aspects, data access point 110 can be included with inside component 140. A wireless method is demonstrated in diagram 100. The data access point 110 can be a conventional type of equipment, for example, a modem, router, wireless extender, access point, and/or a user device.

The communication system 100 may be symmetrically or asymmetrically bi-directional so that data access point 110 can transmit a data signal to wireless data access point 105 through the paired components 140 and 130 for cross-window optical communication. In addition, the components 130 and 140 can be communicatively coupled so that information, instructions, or other data can be exchanged between the components and acted on appropriately without being further transmitted to the wireless data access point 105 or the data access point 110.

FIG. 2 illustrates an example 200 of the apparatus as shown in FIG. 1, which includes the paired components 130 and 140 capable of free-space optical communication across an adjacent window. The example paired components 130 and 140 additionally include antennae 231 and 241, processors 234 and 244, optical transceivers 233 and 243, and induction coils 232. The antenna 231 is capable of sending and receiving a data transmission from distant wireless data access point, for example an outside wireless base station. The antenna 231 can operate on multiple frequencies, for example 28.0 GHz. The received data can be transmitted to processor 234 which is capable of remodulating the data stream of the received wireless signal, for example in the 28.0 GHz to 2.0 GHz frequency range, onto an optical carrier in the optical transceiver 233. Optical transceiver 233 can include a digital data processor and one or more lasers or optical wavelength sources, one or more optical data modulators, lenses, and mirrors required to transform the received wireless signal into a corresponding optical signal 265. The free-space optical signal 265 can be transmitted through the one or more panes 120 and 125 of the window and across the intervening space between the one or more panes 120 and 125. If necessary, the free-space optical signal 265 can be spread in beam width to increase the alignment tolerance between optical units 233 and 243.

Optical transceiver 243 can receive optical signal 265 and remodulate the data stream carried by the optical signal 265 back onto a digital transmission for wireless or wired transmission to processor 244. Processor 244 can further remodulate the received data stream onto to a wireless or electrical carrier, for example in the 2.0 GHz to 5.0 GHz frequency range, for transmission, e.g., using antenna 241, to a data access device. In addition, the free-space optical signal 265 can include instructions, state information, or other data needed by components 130 and 140 to operate effectively, for example, frequency division duplex (FDD) signals, time division duplex (TDD) signals, and signals to aid in beam pointing for the outside antennas. This allows the paired components 130 and 140 to be communicatively coupled as end points of the data transmission process.

In some embodiments, antenna 241 can be a physical connection, for example, an Ethernet receptacle, to allow for a direct connection between component 140 and a data access device. The communication system may be symmetrically or asymmetrically bi-directional so that a communication transmission can flow equally from component 140 to component 130.

FIG. 3 shows a cross-sectional view illustrating an example free space, optical coupling system 300 of the paired components 130 and 140 of the cross-window, optical communication, apparatus. Optical transceiver 233 further includes a laser and data modulator module 331, a laser output 332, and expansion and collimation optical lens(es) 335. Optical transceiver 243 further includes a digital data processing unit 331, optical intensity detector 342, and focusing optical lens(es) 345. In FIG. 3, the view has been expanded to demonstrate the disclosure and does not represent, to scale, the objects shown therein or distance between the objects.

Laser and data modulator module 331 can include a single laser or an array of lasers, for example, an array of VCSELs of the same or different wavelengths. Laser and data modulator module 331 is configured to output one or more data-modulated optical carriers 332 from data received therein. For example, the data-modulated optical carrier(s) may be produced by conventional direct electrical modulation of the laser(s), i.e., digital data-modulation of the electrical driver(s), or by conventional external optical modulation of the light beam(s) output by the laser(s). This optical coupling system 300 implements a method of improving alignment tolerance by expanding the optical beam 332 to a wider diameter, as shown at 365, between the facing optical transceivers 233 and 243. Expansion and collimation optical lens(es) 335 provide the final optical adjustments prior to the data-modulated optical carrier leaving the component 130, as shown in FIG. 1.

The data-modulated optical carrier 367 becomes the optical beam 365 while proceeding to pane 120. The length of the data-modulated optical beam 365 is preferably close to a minimal distance to traverse the panes 120 and 125 of the window. However, due to window manufacturing variances, there is a potential to be some distance for the optical beam to physically cross.

After proceeding through pane 120, the intervening space, and pane 125, the optical transmission 365 continues to the focusing optical lens(es) 345, which begins, and may complete, the focusing of the optical beam 365 onto the optical intensity detector 342, as shown as 368.

The optical intensity detector 342 is typically a photo-sensitive diode or a photo-sensitive transistor that is configured to receive light of the focused optical beam and produce therefrom an electrical output signal that is conventionally digitized and sent to local processor 331. The optical intensity detector 342 can include various types of photo-sensitive diode(s), for example one or more APDs, or can alternative include a photo-sensitive transistor, i.e., constructed to be photo-sensitive a wavelengths of light in the optical beam 365. In addition, photosensitive surface of the optical intensity detector 342 can be of various lateral widths or diameters as needed to achieve an appropriate alignment tolerance for the overall optical cross-window communication system.

FIG. 3 demonstrates the optical data communication in one direction across the window, but the optical communication is typically bi-directional and would include a physically parallel optical communication system for communicating data in an opposite direction, across the window, between the optical transceivers 233 and 243. Said parallel optical communication system may have a similar placement except that positions of components face a different lateral portion of the window and similar optical components are located on the opposite side of the window in comparison to component locations in FIG. 3. For example, the laser and data modulator module 332 and photo diode 342 exist in both components, as well as do the various types of systems of lens as already described herein.

FIG. 4 illustrates a diagram of an example alignment laser array 410. The alignment laser array 410 includes four VCSELs 425 and output lens 420. This type of alignment laser array 410 can be used to increase alignment tolerances by laterally aligning each of VCSEL 425 to a corresponding light detector, e.g., a photo-sensitive diode, on a receiver component so that there is an increased opportunity for at least one VCSEL 425 to provide proper lateral alignment to the photo diode. In other embodiments, various numbers of VCSELs can be used in the alignment laser array 410, i.e., one or move VCSELs.

FIG. 5 illustrates a diagram 500 of an example lateral alignment system using magnets. Expanding a part of the components 130 and 140 as shown in FIG. 1, diagram 500 includes magnets 535 and 545, i.e., sources of dipole magnetic fields. These magnets can automatically set the relative lateral positions of the facing components 130 and 140 and/or can be used similar to 131 and 141 to hold in place and align components 130 and 140. In addition, magnets 535 and 545 can provide automatic complete or partial lateral alignment of the lens 335 and 345 to improving the relative alignment between the components 130 and 140. Magnets 535 and 545 can be conventional magnets. In various embodiments, the magnets 535 and 545 can be electromagnets or solenoids, e.g., controlled by processors 234 and 244. In this embodiment, changes in the electromagnet field generated by the magnetic sources 535 and 545 can adjust the lens 335 and 345 to improve the overall alignment between the components 130 and 140.

In some alternate embodiments, one magnet 535 and 545 of a facing pair of FIG. 5 is replaced by a piece of magnetizable material, e.g., a piece of iron.

FIG. 6 is a block diagram schematically illustrating an example communication system 600 capable of maintaining an optical data link across a window. Communication system 600 includes a wireless data access point 610, a first component of a cross-window optical communication apparatus 630, a second component of a cross-window optical communication apparatus 650, a data access point 615, and a power supply 670. Separating the facing first and second components 630 and 650 is a window 620. Collectively, the components 630 and 650 are the cross-window optical communication apparatus 601, which has no wire or optical fiber connections between the facing paired components 630 and 650.

Wireless data access point 610 is communicatively coupled with second component 650 through a bi-directional communication transmission link 616. First component 630 is communicatively coupled to second component 650 through a bi-directional, free-space optical, data communication link 617. First component 630 and data access point 615 are communicatively coupled through a bi-directional, communication link 618. Link 618 can be a wired or wireless type of communication link, e.g., an RF link. First component 630 is power coupled to power supply 670 through an available method, for example, an electrical socket plug module to an in-building power line. First component 630 is power coupled to second component 650 through a conventional two-part, free space, induction power coupler 675.

Components 630 and 650, include a similar set of modules and units, but they are not required to be the same. The required modules and units for components 630 and 650 are antenna/interface modules 632 and 652, electrical processor modules 633 and 653, induction power modules 636 and 656, and optical transceivers 640 and 660. The required modules of optical transceivers 640 and 660 include laser and data modulator modules 641 and 661, optical intensity detectors 642 and 662, expansion/collimating and focusing lens/mirror modules 643 and 663, and optical transceivers 640 and 660.

Optional modules of components 630 and 650 are magnet modules 631, 637, 651, and 657, alignment light modules 634 and 654, audio modules 635 and 655, magnetic modules 644 and 664, battery modules 638 and 658, flexible edges 639 and 659, and heat shield material 669. Each component 630 and 650, in varying embodiments, can include a different combination of the optional modules as required for the implementation. The optional modules can be absent from a component 630 and/or 650. The enumeration of required and optional modules and units is not exhaustive and various embodiments of this disclosure may include additional modules, units, or elements, for example, a reset button and a power button. In addition, the functionality ascribed to the modules and units presented can be combined or separated in various combinations of modules and units as needed for the implementation. For example, an antenna can be combined with an electrical processor. Also, various quantities of each module and unit of components 630 and 650 may be present in an embodiment, such as including three electrical processor modules, two antenna/interface modules, battery module(s), or another enumerated combination thereof. The presentation of the modules and units demonstrate a logical functionality of the disclosure and not a physical design paradigm.

The first component 630 modules and units are further detailed below. Due to the similarity of components 630 and 650, further details of component 650 will not be presented except where necessary to highlight a difference with component 630.

Antenna/interface module 632 provides for the data communication coupling to data access point 615 via transmission signal 618. This can be by a wireless link or a wired link, for example, an Ethernet wire or cable. For component 650's antenna/interface module 652, antenna/interface module 652 is communicatively coupled to wireless data access point 610 via transmission signal 616.

The antenna/interface module 632 is communicatively coupled to electrical processor 633. Electrical processor 633 handles the transmission as necessary, for example, electrical processor 633 can manipulate analog signals, such as mixing down or up a frequency transmission, and, in other aspects, electrical processor 633 can modulate the optical signal, prioritize transmission packets, and handle transmission packets to be sent through transmission 617 and transmission 618. Electrical processor 633 is communicatively coupled to optical transceiver 640.

Optical transceiver 640 communicatively couples the laser and data modulator module 641, the light intensity detector 642, the expansion/collimating and focusing lens/mirror module 643, electrical processor module 645, and optional magnet module 644. Other modules can be included as required for the implementation. Laser and data modulator module 641 can include a single laser or an array of separately data-modulatable lasers, for example, an array of four directly modulated VCSELs. Optical intensity detector 642 can include a single photo-sensitive diode or photo-sensitive transistor or an array of photo-sensitive diodes or photo-sensitive transistors, for example, an APD may be used in some embodiments. The size, wavelength-sensitivity, and responsivity of the photo-sensitive diodes or transistors used can vary through different embodiments. The expansion/collimating and focusing lens/mirror module 643 can include one or more lenses and zero or more mirrors. The lens type, the inclusion of mirrors, and the type of mirrors utilized can vary through different embodiments. Electrical processor 645 can process received transmissions through the light intensity detector 642 and can process transmissions to be sent through the laser and data modulator module 641. For example, electrical processor 645 can manipulate the analog signals and, in other embodiments, can transform a received digital data stream to electrical signals to drive the laser of the laser and data modulator module 641.

Optional magnet module 644 can include one or more magnets and/or iron objects that can be used to aid in automatically aligning the optical modules of components 630 and 650. Magnet module 644 can include one or more permanent magnets and/or electromagnets, and/or objects of iron or another ferromagnetic material attracted to conventional magnets.

Returning to the modules of components 630 and 650, component 630 includes a conventional induction power module 636 capable of delivering power to the component 650, which is located outside of the window, via the induction power module 656 of the other component 650. Such inductive powering can enable the component 650, which may be located outside of a building to be powered, by the component 630, which may be located inside the building, without the need for a battery therein or an electrical power cord attached to the outside component 650. In some such embodiments, the induction power modules 636 and 656 are operated at a frequency that provides a resonant inductive coupling there between. Such inductive couplings are typically at frequencies much lower than frequencies for which metal or metal oxide window coatings cause strong or excessive attenuation of wireless signals. In another embodiment, the second or outside component 650 can receive power through a separate power supply similar to power supply 670, such as if the window 620 thickness or material is in a state where induction power transfer is not practical.

Light module 634 can be included to provide indicators to a user on the state or status of the relative lateral alignment of the facing components 630 and 650 or the alignment of the apparatus as a whole. Various quantities of light modules 634 can be included and each light module 634 can include various quantities and can generate a plurality of colors. The light modules 634 can be located anywhere on component 630. For example, light module 634 can be used to indicate a relative optical alignment issue with the other component 650 and to aid in guiding a user-installer to find a better relative alignment position.

Audio module 635 can be included to provide indicators to a user-installer on the state or status of the component or apparatus as a whole. For example, audio module 635 can be used to indicate a non-adequate relative optical alignment and aid the relative alignment by guiding a user-installer to find a better relative-alignment of the components 630 and 650. Audio module 635 can include a speaker and produce one or more tones, sounds, or recorded music or instructions, including voice instructions, to guide an installer in relatively moving one or more of the components 630 and 650 towards a suitable relative alignment as needed.

Battery module 638 can be included to provide power to the component 630 in case the primary power is disconnected or not operable. For example, during a power outage, the component can continue to operate to maintain communication coupling with battery operated data access points, or data access points connected to an uninterruptable power supply or power coupled to a generator.

Magnet modules 631 and 637 can be included to provide a mechanism for automatically attaching components 630 and 650 to facing surface areas of the window 620. Magnetic source modules 631 and 638 can also be utilized to aid in guiding a user to align the optical transceivers 640 and 660 of the respective components 630 and 650.

Flexible edge 639 can also be included as part of the component 630 to provide a flexible or soft edge of component 630 when placed against the surface of the window 620. Flexible edge 639 may provide for increased angle alignment correction.

Heat shield material 669 can be included in second or outside component 650 to provide insulation, for example, to prevent sunshine from raising the operating temperature of the second component 650 beyond an acceptable level. Heat shield material 669 can be place anywhere within the second component 650, on the outside of second component 650, or be part of the housing of second component 650.

FIG. 7 illustrates a flow diagram of an example method 700 for sending data between an inside data access point and an outside wireless data access point. The method begins at a step 701 and proceeds to a step 705 where two components are located to face each other across a surface area of a window. One component is adjacent the first side of the window and the other component is adjacent the second side of the window. The window is typically part of a unit that divides an inside of a building and an outside of building, but the window does not need to provide this type of division. In another embodiment, one component, attached to a power supply, can provide power to the other component via a pair of induction coils.

Proceeding to a step 710, a first component receives a data transmission from a first data access point. Either component can be the first component at this step as the method may be bi-directional. Method 700 operates starting at either component. Depending on the equipment involved, if the first component is located on an inside of a window, then the data can be received via a wireless transmission or via a wired data access point, for example, from a modem, router, access point, wireless extender, or other device. If the first component is located on an outside of a building, then the data can be received by a wireless data access point, for example, from a base station or other juncture equipment.

Proceeding to a step 715, the first component can process a received wireless or wired transmission so that the data stream thereon can be further processed by the first components optical transceiver, for example, modulating from a 28.0 GHz signal to a 2.0 GHz signal. Proceeding to a step 720, the first component's optical transceiver can convert the received data stream transmission into an appropriate frequency signal and further modulate the laser to generate a free-space optical beam transmitted towards the facing second component at the other surface of the window. In some embodiments, the process of converting the received data stream into a free-space optical beam can include expanding a diameter of the optical beam, e.g., to improve alignment tolerance between the facing components.

Proceeding to a step 730, the second component receives the data stream from the received optical beam and remodulates said data stream onto an appropriate wireless electrical carrier, at an appropriate frequency, for example 28.0 GHz or 5.0 GHz, e.g., for transmission to a second data access point on the same side of the window. In another aspect, a modem can be included in the second component. In another embodiment, when the optical signal is received by the second component, amplification is applied to the received optical signal to compensate for attenuation.

FIG. 8 illustrates a flow diagram of an example method 800 for aligning an inside component with an outside component. The method begins at a step 801 and proceeds to a step 805 where a first component is mounted on one side of a window. In one embodiment, the first component can be mounted via adhesive. The adhesive can be conductive or non-conductive electrically and optically as needed for the type of component being mounted.

Proceeding to a step 810, a second component can be attached to the opposite side of the window proximate to the first component. The attachment of the second component can use a non-permanent or permanent method of attachment.

Proceeding to a step 815, the second component is adjusted to bring the optical units of the first component and second component in alignment. The adjustments can be of several types, for example, adjustments horizontally and vertically, such as the (x,y) plane of the window pane, and adjustments in angle of attachment of the component to the window pane.

In one embodiment, the adjustment can be aided, at a step 820, by a set of indicator lights on the first and/or second components. In another embodiment, the adjustment can be aided, at a step 820, by a set of audible tones. In another embodiment, the adjustment can be aided, at a step 820, by a set of magnets guiding the alignment process. Alternatively, these adjustment embodiments can be utilized together in various combinations. In another embodiment, the adjustment can be aided by a lens leveling mechanism in one or both components. In another embodiment, one or both of the components can have a soft or flexible mounting edge that is placed against the window allowing angle adjustments of the optical unit relative to the surface of the window pane. Any of these embodiments can be combined to allow multiple alignment methods and aids.

In a step 825, the adjustment process is finalized. The finalization step can be that a user no longer moves the component, activation or application of a permanent hold system, such as activating a magnetic source, or another action can occur. The method ends at a step 850.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

Those skilled in the art to which this application relates will appreciate that other and further additions, deletions, substitutions and modifications may be made to the described embodiments. It is also to be understood that the terminology used herein is for the purpose of describing particular embodiments only, and is not intended to be limiting, since the scope of the inventions will be limited only by the claims.

Unless defined otherwise, all technical and scientific terms used herein have the same meaning as commonly understood by one of ordinary skill in the art to which this invention belongs. Although various methods and materials similar or equivalent to those described herein can also be used in the practice or testing of the present invention, a limited quantity of the exemplary methods and materials are described herein.

It is noted that as used herein and in the appended claims, the singular forms “a”, “an”, and “the” include plural referents unless the context clearly dictates otherwise.

What is claimed is:

1. An apparatus, comprising:
physically separate first component and second component, each of the components including an optical data transceiver; and
wherein said optical data transceivers of said first and second components are capable of forming a free-space optical communication link when the components are facing each other along opposite surface areas of a window.

2. The apparatus as recited in claim 1, wherein said first and second components include induction coils operable to enable one of the components to inductively power the remaining of said components when said components are located along opposite surface areas of a window.

3. The apparatus as recited in claim 1, wherein said first component includes an optical beam collimator configured to form a collimated light beam whose diameter is at least 2.0 times a diameter of an output aperture of the optical transceiver of the first component.

4. The apparatus as recited in claim 3, wherein said second component includes focusing optics configured to focus the collimated light beam from the first component onto an area of an optical intensity detector in the second component, said area having a diameter at least 2.0 times smaller than a diameter of the beam.

5. The apparatus as recited in claim 1, wherein, at least, one of said components includes one or more magnets capable of relatively laterally aligning said components across said window.

6. The apparatus of claim 1, wherein one of said components has an array of light sources and the remaining of said components has an array of light detectors and is configured to provide an indication of whether the light sources are laterally aligned across the window with the array of detectors.

7. The apparatus as recited in claim 6, wherein said light sources are vertical cavity surface emitting lasers.

8. The apparatus as recited in claim 1, wherein said first component includes a first leveling mechanism and said second component includes a second leveling mechanism.

9. The apparatus as recited in claim 1, wherein one of said first component and said second component is configured to provide visual or audio feedback relating to the relative lateral alignment of the components across the window.

10. The apparatus as recited in claim 1, wherein said second component is configured to be located on an outside surface of a window and includes a sun shield.

11. The apparatus as recited in claim 1, wherein said first component includes a first antenna system capable of being communicatively coupled to a first wireless data access point and said second component includes a communication system capable of being communicatively coupled to a second data access point.

12. A method, comprising:
locating a first component on a window and a second component on an opposite side of said window, such that the first and second components face each other across the window; and
wherein the first and second components are capable of forming a free-space optical data link therebetween across the window.

13. The method of claim 12, wherein the locating includes optically relatively laterally aligning an optical output of an optical transceiver on the first component with an optical input of an optical transceiver of the second component.

14. The method of claim 12, further comprising establishing a wireless data link between one of the components and a wireless access node on the same side of the window.

15. The method as recited in claim 12, further comprising:
inductively powering one of said first and second components through the other of said first and second components.

16. The method as recited in claim 12, wherein said aligning includes, across the window, laterally aligning a lateral array of light sources on one of the components with a lateral array of optical intensity detectors on the other of said components.

17. A method comprising:
locating a first component along a first side of a window;
locating a second component along a second side of said window; and
adjusting said second component such that said components face each other across said window, wherein said adjusting includes using at least one of a set of alignment light indicators, a set of audible tones, and an alignment magnet.

18. The method as recited in claim 17, wherein said adjusting includes leveling said first component using a first leveling system thereon and leveling said second component using a second leveling system thereon.

19. The method as recited in claim 17, wherein said adjusting includes molding a flexible edge material located between said first component and said first side of said window, and a flexible edge material located between said second component and said second side of said window.

20. The method as recited in claim 17, further comprising:
securing said first and second components to said respective side of said window utilizing one or more of magnets, adhesive, clips, brackets, and fasteners.
